(19) United States
(12) Patent Application Publication
(10) Pub. No.: US 2017/0196754 A1
(43) Pub. Date: Jul. 13, 2017

(54) Device for Packaging and/or Applying a Cosmetic Product

(71) Applicant: L'OREAL, Paris (FR)

(72) Inventor: Laure THIEBAUT, Clichy (FR)

(73) Assignee: L'OREAL, Paris (FR)

(21) Appl. No.: 15/326,095

(22) PCT Filed: Jul. 15, 2015
(86) PCT No.: PCT/EP2015/066134

§ 371 Date: Jan. 13, 2017

(30) Foreign Application Priority Data
Jul. 16, 2014 (FR) 1456814

(51) Int. Cl. A61H 9/00; A45D 40/26; A45D 34/04

(52) U.S. Cl. CPC A61H 9/0057; A45D 34/041; A45D 40/261; A61H 2201/0153; A61H 2205/022

(57) ABSTRACT

Device (10) for packaging and/or applying a cosmetic product, including: an applicator (20) and/or a reservoir of product, a device (30) for treatment of the skin by suction, adapted to be removably fixed to the applicator (20) and/or the reservoir, including a tip to be applied to the skin, communicating with an internal chamber of variable volume, the treatment device (30) having at least one lateral actuation surface (60) on which the user may press to cause elastic deformation of and reduction of the volume of the chamber, the latter tending to resume its initial shape by elasticity.

The present invention concerns treatment of the skin, and notably devices intended to favour the action of a cosmetic product.

The invention more particularly concerns treatment devices that expose the skin to suction.

Massage of the skin by application of a vacuum, also known as suction massage, has been known and practised since very ancient times.

The suction, which may be created by means of a sucker heated and applied to the skin or by means of a sucker connected to a vacuum source, generates a local afflux of blood and activates the lymph system, among other effects.

There therefore exist anti-ageing facial suckers suitable for the face that can attenuate wrinkles and scars by the suction created, assist to dislodge excess oil and impurities that block the pores, improve the local circulation of blood, favour the reduction of dark rings under the eyes, increase the feeding of nutrients into the epidermis, drain off stagnant fluids and reduce oedemas and puffiness.

Also known are electrical machines to which various sorts of suckers may be fixed depending on the area to be treated and the required effect.

French Patent Application FR 2 956 954 discloses a packaging and suction massage device including a container equipped with a sucker at its distal end. The container contains a cosmetic product that can be dispensed onto the area to be treated through the sucker.

The application GB 2 092 003 discloses a device for treating the skin including a treatment tip driven by a motor.

The publication WO 03/047491 discloses a device for submitting the skin to suction.

The application WO 03/096961 Al discloses a device for simultaneously exerting suction on the skin and subjecting the latter to treatment by a rotating brush.

The application FR 2 969 927 discloses a packaging and suction massage device including a sucker.

The devices described in the applications mentioned above tend to create relatively strong suction and are not particularly suitable for the treatment of wrinkles, notably those on the face, and in particular wrinkles present in sensitive areas of the skin such as around the eye.

There therefore remains a requirement for further improvement of skin treatment devices, notably for use in sensitive areas such as around the eye.

The invention aims to address this requirement, and achieves this thanks to a device for packaging and/or applying a cosmetic product, including:

an applicator and/or a reservoir of product,

a device for treatment of the skin by suction, adapted to be removably fixed to the applicator and/or the reservoir, including a tip to be applied to the skin, communicating with an internal chamber of variable volume, the treatment device having at least one lateral actuation surface on which the user may press to cause elastic deformation of and reduction of the volume of the chamber, the latter tending to resume its initial shape by elasticity.

Thanks to the invention, the treatment device can very easily be used in conjunction with the application of the product contained in the reservoir, which may take place before or after exposing the skin to suction.

Reducing the volume of the chamber by pressing on a lateral surface of the treatment device makes it very easy for the user to create suction by holding the treatment device between the thumb and the index finger and pressing with one of them on the actuation surface or with both of them on both actuation surfaces.

The limited overall size of the device, stemming from the constraint of mounting on the applicator and/or the reservoir, proves entirely compatible with the small volume of the chamber, which makes it possible to limit the vacuum created to a value sufficiently low not to mark a sensitive area on the skin such as around the eye.

The treatment device may have a single lateral actuation surface. The treatment device preferably has two diametrically opposite lateral surfaces that the user can actuate simultaneously with the thumb and the index finger. Manually actuating two actuation surfaces can increase the variation in the volume of the chamber without requiring the user to depress each actuation surface a long way.

The treatment device preferably includes a body made from a relatively rigid first material, notably a plastic material, and the internal chamber is preferably defined by at least one wall made from a second material, notably a plastic material, less rigid than the first. This second material is an elastomer or a rubber, for example.

This can make it possible to produce by moulding with the first material a shape suitable for fixing to the applicator and/or the reservoir, for example a screwthread, a bead, a clipping tooth or a friction or bayonet mounting skirt. The treatment device may further include a pressed metal part with an added fixing part glued or crimped on.

The first material is for example chosen from plastic materials such as PP, POM, ABS, PBT or a metal.

The second material is for example a thermoplastic elastomer, notably chosen from SEBS, TPE, silicone, nitrile, rubber.

The aforementioned wall may define the actuation surface directly. It is for example accessible in an opening in the body of the treatment device. The wall is present in the opening in the body, for example, which it blocks, or across the opening in the body, which then constitutes a window providing access to said wall. Alternatively, this wall is covered by another element and the user therefore does press directly on it. It is the other element, on which the user presses, that transmits the pressure necessary for the deformation of the wall. This other element may be carried by said wall or alternatively be produced from the first material by moulding it with said body. Said element may also be connected to the body by a hinge.

The first and second materials, notably when they are plastic materials, are preferably bi-injected or moulded one onto the other. They may also be assembled.

The tip of the treatment device is preferably made in one piece with said wall, notably by moulding material. The tip is therefore flexible and comfortable when in contact with the skin.

The tip may include a circular or non-circular, notably elliptical, opening. An opening of elongate shape proves particularly suitable for the treatment of large and small wrinkles around the eye. A position with the major axis of its cross-section oriented in the direction of the wrinkle is particularly suitable for the treatment of small wrinkles while a position transverse to the direction of the wrinkle is more suitable for large wrinkles.

The chamber may be defined by an insert which is moulded into the body of the device, for example. The tip maybe moulded with this insert. The latter may define one or two actuation surfaces. The treatment device can therefore be produced entirely by a process of moulding material, with no assembly step entailing mounting one part on another. The aforementioned wall may be defined by a portion of said insert, which lies for example inside or behind an opening of the body.

The chamber may further be defined by means of a plug produced separately and mounted in the body. In this case, the volume of the chamber may be varied by means of one or two walls moulded into openings in the body, defining one or two buttons which the user can press, this button or these buttons therefore each defining an actuation surface. The button or buttons may be moulded with the tip.

The applicator may include an application member, or the reservoir may include a dispensing orifice, and the treatment device serve as closure cap for protecting this applicator member or this dispensing orifice when not in use.

The device may include a protective cap that is removably fixed to the tip. This protective cap may serve as a base in order for the device to stand vertically on a plane horizontal surface.

The tip may optionally have an outwardly flared shape, of greater or lesser width depending on the size of the area to be treated. The opening of the tip may have a section of between 50 and 300 mm² and preferably 100 to 200 mm².

The volume of the chamber may be between 1000 and 5000 mm³ and preferably between 3000 and 4000 mm³.

The maximum variation in the volume of the internal chamber in use is preferably between 300 and 1000 mm³.

The manual movement of the actuation surface or each actuation surface by the user to reduce the internal volume of the chamber is preferably between 1 and 5 mm and preferably 1 to 3 mm.

The treatment device preferably has a tubular body, preferably moulded from a non-elastomer plastic material, this body optionally being compartmented, which can make it possible to produce the entire device in the general shape of a pen, easy to hold in one hand. This body may be continuous with the exterior surface of the applicator and/or the reservoir.

The body of the treatment device may have a distal part of tapered shape. This tends to improve the visibility of the tip and the accuracy of the treatment. The treatment device in accordance with the invention is then easy to manipulate and enables the user to treat areas of the face or the body without effort.

The invention further consists in a method of non-therapeutic cosmetic treatment including the steps of:

manually exerting a thrust on the actuation surface to reduce the interior volume of the chamber,

applying the tip to the area to be treated,

releasing the actuation surface and subjecting the area to be treated, notably an area of the face with wrinkles, to suction caused by the propensity of chamber to resume its initial shape.

The method may include the step of moving the tip over the skin in a direction recommended for the treatment.

The method may include applying the product contained in the reservoir and/or the applicator before or after applying suction.

The product is not dispensed via the tip.

Nevertheless, the tip may optionally assist with spreading the product present on the skin beforehand. The product allows the sliding movement of the tip while maintaining the suction.

The invention may be better understood by reading the following detailed description of nonlimiting embodiments thereof and examining the appended drawings, in which:

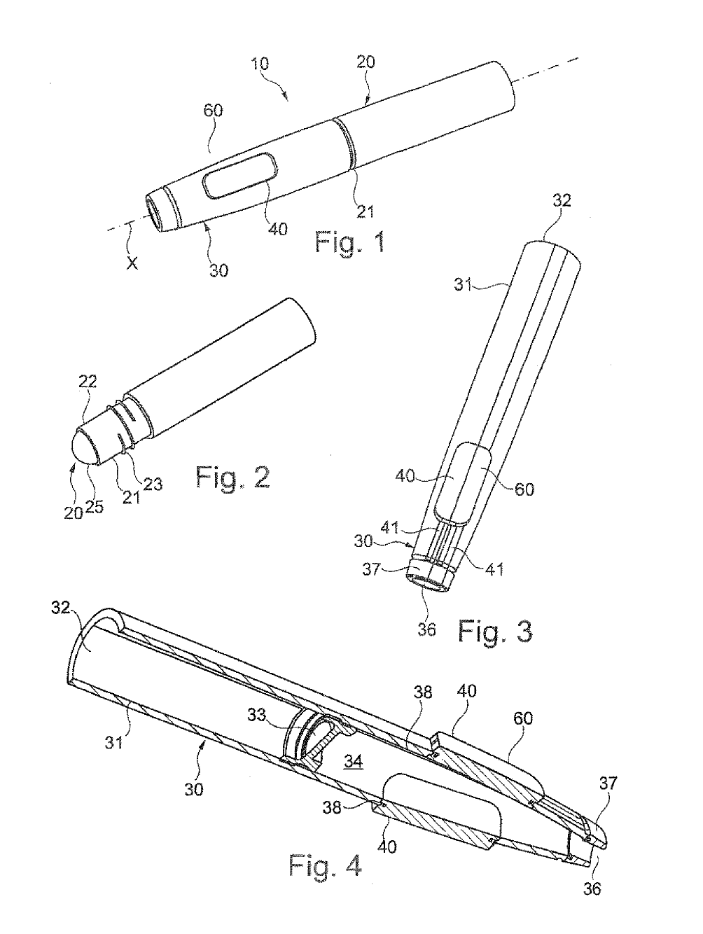

FIG. 1 represents in perspective one example of a packaging and application device in accordance with the invention,

FIG. 2 represents separately the applicator of the device from FIG. 1,

FIG. 3 represents separately the treatment device in accordance with the invention,

FIG. 4 is an axial half-section of the device from FIG. 3,

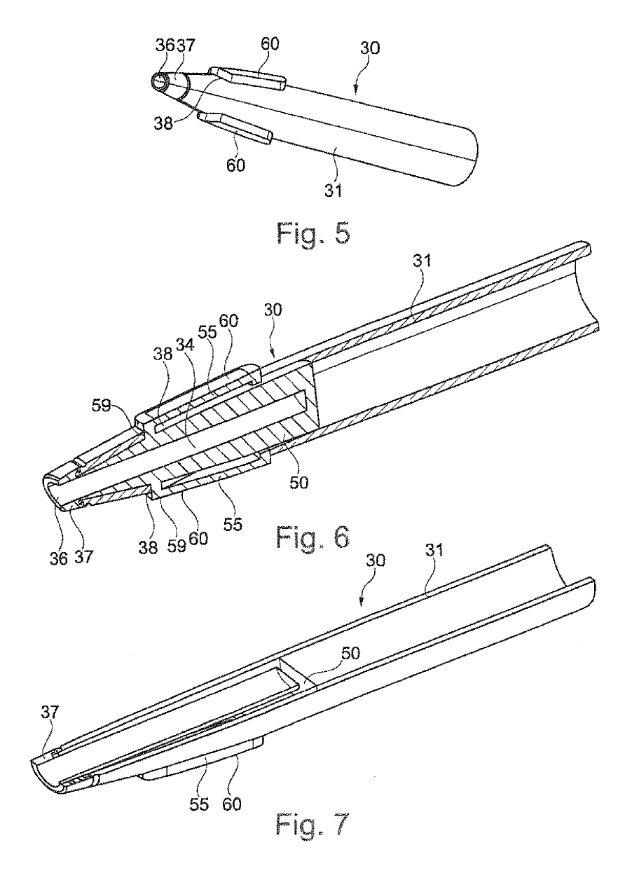

FIG. 5 is a view analogous to FIG. 3 of a variant of the device,

FIGS. 6 and 7 are two half-sections of the device from FIG. 5 on mutually perpendicular section planes,

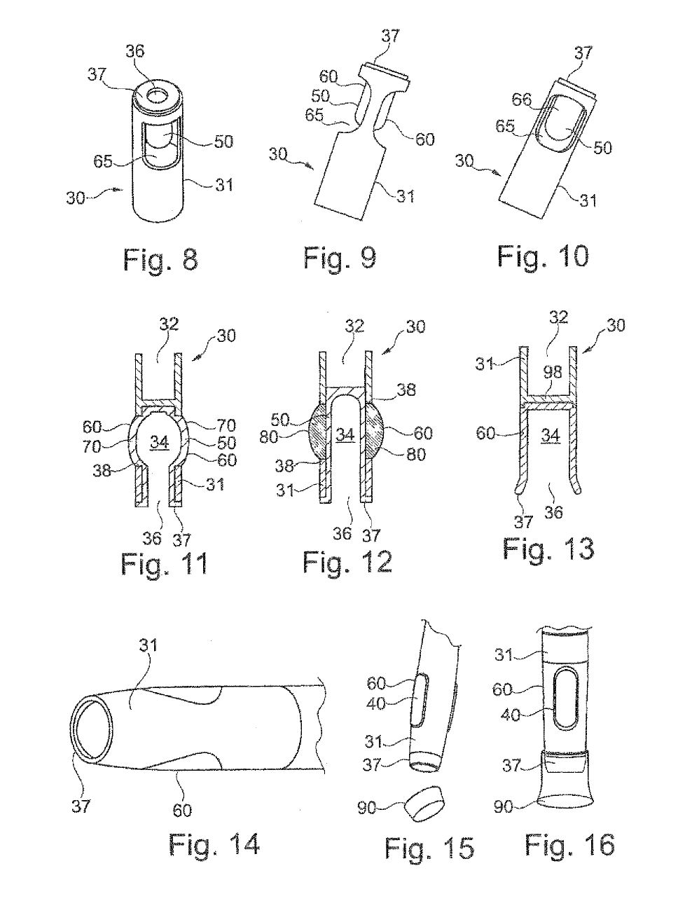

FIGS. 8 to 10 represent three perspective views of the same variant embodiment as seen from different angles,

FIGS. 11 to 13 are axial sections of other variant embodiments of the treatment device,

FIG. 14 represents partially and in perspective a variant of the treatment device,

FIGS. 15 and 16 illustrate the possibility of covering the tip of a treatment device in accordance with the invention with a protective cap,

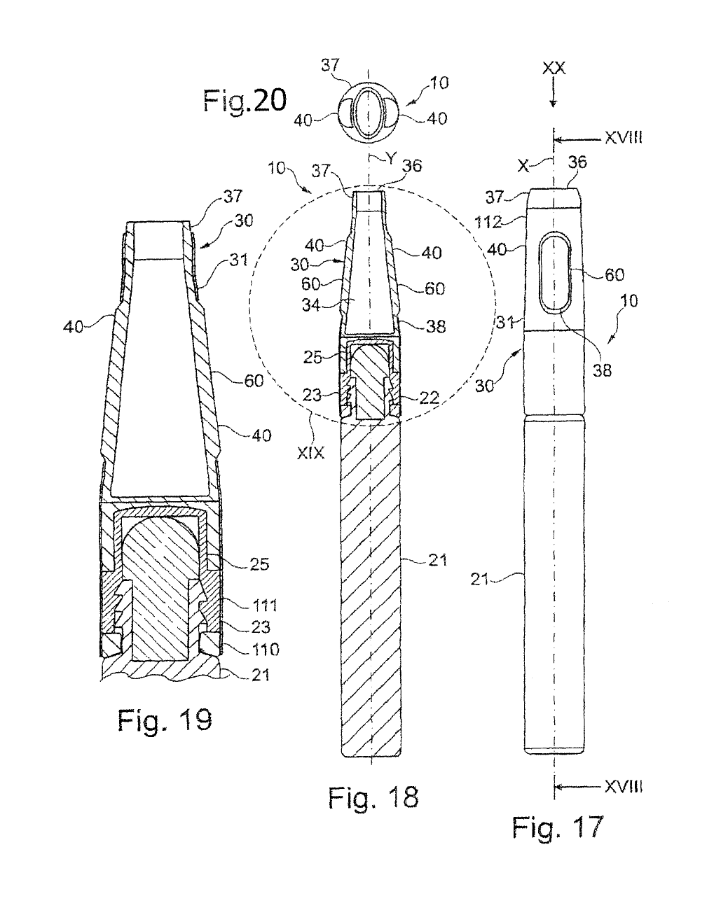

FIG. 17 represents a variant device in elevation,

FIG. 18 is longitudinal section of the device from FIG. 17 taken along the line XVIII-XVIII,

FIG. 19 represents the detail XIX from FIG. 18, and

FIG. 20 is a view from above in the direction XX in FIG. 17.

The packaging and application device 10 in accordance with the invention represented in FIGS. 1 to 4 includes an applicator 20 and a treatment device 30, being of elongate general shape along a longitudinal axis X. The device 10 shown advantageously has the general shape of a pen, easy to manipulate, and can notably be gripped between the thumb and the index finger.

The applicator 20 may be of any type and includes a body 21 that defines a reservoir containing a cosmetic product to be applied, for example an anti-wrinkle product.

This body 21 may have a head 22, as shown in. FIG. 2, which is produced with a screwthread 23 enabling the device 30 to be screwed onto the applicator 20.

The head 22 carries an applicator member 25 for applying the product contained in the reservoir to the skin.

This applicator member 25 shown consists of an applicator ball, for example, but may alternatively be replaced by any other known applicator member, such as a felt tip, a brush, a foam tip or a flocked tip. Alternatively, the product contained in the reservoir may be dispensed by means of a pump or a valve or by taking it directly from the reservoir, the latter being a pot having a wide opening, for example.

The applicator 20 may if necessary be replaced by a reservoir with no particular applicator means, notably with simple nozzle, and with a simple orifice through which the product is dispensed, for example onto a finger or onto the area to be treated, or onto an additional applicator that is not part of the device 10.

The applicator 20 and the treatment device 30 are removably fixed to each other by screwing them together. When in place, the treatment device 30 serves as cap for closing and protecting the applicator 20.

The device 30 has a body 31 made from a first plastic material, rigid, plastic or metal for example.

The body 31 has a tubular general shape along an axis X, being open at its proximal end 32 for fixing it to the applicator 20.

In FIG. 4, the screwthread on the internal surface of the body 31 for fixing it to the applicator 20 has not been shown in order to simplify the drawing.

The body 31 houses a plug 33 that delimits axially an internal chamber 34 inside the body 31.

The body 31 includes at its distal end a tip 37 made from a flexible plastic material, preferably an elastomer material, while the first material from which the body 31 is made is preferably a non-elastomer material.

The opening 36 defined by the tip 37 shown here is preferably of non-circular section, for example elliptical for better ergonomics.

The opening 36 may lie in a plane perpendicular to the axis X, as shown here. Alternatively, the opening 36 lies in an oblique plane.

The body 31 may have a general shape that, as shown here, becomes flatter and smaller toward the tip 37.

The distal part of the body 31 between the plug 33 and the tip 37 is produced with two diametrically opposite openings 38 that accommodate respective buttons 40 each formed by an elastically deformable wall. Each of the walls of the buttons 40 is preferably moulded in one piece with the tip 37 from the flexible second plastic material.

To this end, bridges 41 of material can connect the buttons 40 to the tip 37, as can notably be seen in FIG. 3. The flexibility of the tip 37 has the advantage of making contact with the skin more comfortable and of producing a better contact seal to generate the suction.

The buttons 40 are preferably thicker than the wall of the body 31 to facilitate pressing their top by the user.

To use the device 10, the user may begin by separating the applicator 20 from the treatment device 30 by unscrewing it.

The user can then apply the product contained in the applicator 20 to a wrinkle, for example.

The user can then execute a suction massage by pressing the flexible tip 37 onto the skin, after reducing the volume of the chamber 34 by pressing on the buttons 40.

The user may release the buttons 40 while the tip 37 is pressed onto the area to be treated in a sealed manner.

Tending to resume their initial shape by elasticity, the buttons 40 create a slight suction inside the chamber 34. The user can then slide the tip along the wrinkle with a to-and-fro motion.

The user may repeat the operation, moving over the area to be treated. To eliminate the suction, the user presses on the buttons 40 again to eliminate the reduction in pressure. During use of the treatment device 30, the latter may be mounted on the applicator 20 or not.

In a variant, the suction massage is effected first, after which the product is then applied. This can make it possible to avoid getting the product on the tip 37.

The presence of product at the time of application is nevertheless preferred because it can facilitate sliding and reduce the risk of marking the skin.

A variant embodiment of the treatment device 30 is represented in FIGS. 5 to 7.

In this variant, the body 31 receives a hollow part 50 produced by overmoulding which in itself entirely defines the variable volume chamber 34.

The distal portion of the overmoulded part 50 constitutes the tip 37 to be applied to the skin.

The body 31 is made with diametrically opposite openings 38 in which lie plates connected to the body by thin hinges enabling inward movement. The openings are covered by buttons 55 moulded with the rest of the insert 50 and defining the actuation surfaces 60.

When the user presses on the buttons 55, they move the aforementioned plates and reduce the volume of the chamber 34.

Tending to resume its initial shape by elasticity, the overmoulded part 50 will create the required suction.

In the example shown, the buttons 55 are connected to the rest of the overmoulded part 50 by bridges 59 situated at the distal end of the openings 38.

Alternatively, the overmoulded part is produced without the buttons 55 or with portions defining actuation surfaces 60 having some other shape.

Another variant embodiment of the treatment device 30 is represented in FIGS. 8 to 10.

In this embodiment, the body 31 is produced with two openings 65, also referred to as diametrically opposite windows, that enable the user to access a hollow insert 50 that defines the variable volume chamber 34.

The insert 50 includes a body 66 of tubular shape, for example, closed at its proximal end, and a head fixed to the body 31 and defining the tip 37, through which passes an orifice 36 of circular shape, for example.

At the end opposite the tip 37, the body 31 is hollow for mounting it on the applicator 20 and defines a circular cylindrical mounting skirt, for example.

In the embodiment of FIGS. 8 to 10, the insert 50 may be moulded onto the body 31 or produced separately and then assembled to it. The user presses directly on the body 66 of the insert through the windows 65.

In the embodiment shown in FIG. 11, the insert 50 has at the location of the openings 38 outwardly domed portions 70 that project on the exterior surface of the body 31 and define the actuation surfaces 60 on which the user may press to reduce the volume of the chamber 34. The wall 33 is moulded with the body 31.

The tip 37 is moulded in one piece with the portions 70. The presence of a body section 31 between the portions 70 and the tip 37 makes it possible to stiffen the device 30 between the portions 70 and the tip 37.

In the variant shown in FIG. 12, the chamber 34 is defined by an insert 50 that is covered by elements 80 in the openings 38. These elements 80 define the actuation surfaces 60 on which the user must press to reduce the volume of the chamber 34. The elements 80 are moulded onto the flexible wall of the insert 50, for example, and are made from a material more rigid than that of the insert 50, for example.

In the variant shown in FIG. 13, the chamber 34 is defined by a tip 37 the lateral wall of which, of circular cylindrical shape, for example, defines the actuation surface 60.

This tip 37 is fixed at its proximal end to a transverse wall 98 of the body 31, for example, by gluing, welding or clipping it, for example.

The tip 37 may be produced in various ways, and may project axially only slightly from the body 31, for example, as shown in FIG. 14.

The device 30 may include a protective cap 90 adapted to be fixed to the tip 37 or the body 31, as shown in FIGS. 15 and 16.

This cap 90 makes it possible to close the chamber 34 and may be fixed to the external surface of the tip 37 by friction, for example.

As shown in FIG. 16, the cap 90 serves as a base and enables the device 10 to stand vertically on a plane horizontal surface, if necessary.

In the embodiments of FIGS. 17 to 20, the treatment device 30 is adapted to be fixed to an applicator pen. The latter is provided with a threaded neck 23, for example, onto which the treatment device 30 is screwed. The latter device may include a body 31 having a circular cylindrical proximal part along an axis X in which is present a closure plug 111 adapted to be screwed onto the neck 23.

The body 31 has a distal part 112 of frustoconical shape converging in the direction away from the applicator pen and including two diametrically opposite openings 38.

The body 31 is extended at the front by a tip 37 made from a elastomer material with a hollow body including two buttons 40 lying in the openings 38 and constituting actuation surfaces 60 on which the user can press to reduce the interior volume of the chamber 34.

The tip 37 is preferably of elliptical section with its major axis Y oriented parallel to a median plane extending between the two buttons 40.

Generally speaking, the device 30 may be used in conjunction with a cosmetic product such as a moisturizer product, an anti-wrinkle product, an ant-dark rings product, an anti-scarring product, an anti-stretchmark product, or an oil applied before and/or after subjecting the skin to suction.

The treatment device 30 may be fixed to the applicator or the reservoir other than by screwing, for example by finishing, clipping or bayonet mounting.

The reservoir may be in the form of tube, bottle, pump-bottle, aerosol can or pot.

The expression “including a” must be understood as being synonymous with “including at least one”.

1. Device for packaging and/or applying a cosmetic product, including:
an applicator and/or a reservoir of product,
a device for treatment of the skin by suction, adapted to be removably fixed to the applicator and/or the reservoir, including a tip to be applied to the skin, communicating with an internal chamber of variable volume, the treatment device having at least one lateral actuation surface on which the user may press to cause elastic deformation of and reduction of the volume of the chamber, the latter tending to resume its initial shape by elasticity.

2. Packaging and/or application device according to claim 1, the treatment device including a body made of a relatively rigid first material, the internal chamber being defined by at least one wall made from a second material less rigid than the first.

3. Device according to claim 2, the body being produced by moulding with a shape suitable for fixing it to the applicator and/or the reservoir.

4. Device according to claim 2, the wall directly defining the actuation surface.

5. Device according to claim 2, the wall being covered by another element defining the actuation surface.

6. Device according to claim 2, the first and second materials being plastic materials and being bi-injected or moulded one over the other.

7. Device according to claim 2, the tip of the treatment device being made in one piece with said wall.

8. Device according to claim 1, the tip including a non-circular.

9. Device according to any claim 1, an opening in the tip having a section between 50 and 300 mm².

10. Device according to claim 1, a maximum variation in the volume of the internal chamber during use being between 300 and 1000 mm³.

11. Device according to claim 1, a movement of the actuation surface by the user to reduce the internal volume of the chamber being between 1 and 5 mm.

12. Device according to claim 1, the treatment device including a body having a distal part of tapered shape.

13. Device according to claim 1, including a cap for protecting the tip.

14. Device according to claim 1, having two diametrically opposite actuation surfaces.

15. Method of cosmetic treatment, using a device as defined in claim 1, including:
manually exerting a thrust on the actuation surface to reduce the interior volume of the chamber,
applying the tip to the area to be treated,
releasing the actuation surface and subjecting the area to be treated to suction caused by the propensity of chamber to resume its initial shape.

16. Method according to claim 18, including moving the device by sliding it over the skin.

17. Device according to claim 4, the wall being disposed in an opening in the body or accessible via an opening therein.

18. Device according to claim 9, the opening being elliptical.

19. Device according to claim 13, the movement being between 1 and 3 mm.
